(19) United States
(12) Patent Application Publication
(10) Pub. No.: US 2007/0179886 A1
(43) Pub. Date: Aug. 2, 2007

(54) Method for facilitating payment of a billing statement

(75) Inventors: Paul James Bailo, Trumbull, CT (US); Douglas DiPaola, Pembroke Pines, FL (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/108,836

(22) Filed: Apr. 19, 2005

(51) Int. Cl. G06Q 40/00

(52) U.S. Cl. 705/40

(57) ABSTRACT

A method for receiving payment from an account holder that does not require the account holder to write a check. The method includes the following steps: (a) issuing a periodic statement to the account holder, the statement including an amount owed by the account holder, checking account information of the account holder, and means for the account holder to authorize a deduction of a payment amount from the account holder's checking account; (b) receiving the periodic statement from the account holder, the received periodic statement including the account holder's authorization to deduct the payment amount from the account holder's checking account; and (c) deducting the payment amount from the account holder's checking account.

### BACKGROUND OF THE INVENTION

1. Field of the Invention

The present invention generally relates to methods for paying statements and more particularly to methods for facilitating payment of statements.

2. Related Art

Many payees (e.g., credit card companies, mortgage companies, etc.) issue periodic billing/payment statements to payers (e.g., credit card account holders, home owners, etc.) to collect payment of a payment amount owed to the payee by the payer. For example, FIG. 1 illustrates a conventional method 100 by which a payee receives payment of a statement from a payer. Method 100 begins at a step 110 in which the payee issues a statement to an account holder. In step 120, the account holder writes a check for the payment amount. In step 130, the account holder sends the check and at least a portion of the statement to the payee. Finally, in step 140, the payment amount is deducted from the account holder's checking account.

A problem with conventional payment method 100 is that an account holder is required to write a paper check. The necessity of writing a paper check can be problematic for several reasons. For example, money and natural resources are wasted in producing and utilizing the checks; customer satisfaction may decrease, since paying the statement requires that a customer write a check; and processing paper checks can lead to errors.

Given the foregoing, what is needed is a method for facilitating payment of a statement that does not require the use of a check.

### BRIEF DESCRIPTION OF THE INVENTION

The present invention meets the above-identified needs by providing a method for facilitating payment of a statement that does not require the use of a check.

According to an embodiment of the present invention there is provided a method for producing a statement that can be paid by a payer without requiring a check. The method includes the steps of: (a) providing the payer's checking account information on the payment statement; and (b) providing means on the payment statement to solicit payer authorization to charge the payer's checking account a payment amount.

According to another embodiment of the present invention there is provided a method for facilitating payment of a statement by a payer. The method includes the following steps: (a) producing a statement that includes an amount owed by the payer, checking account information of the payer, and means on the statement to solicit payer authorization to charge the payer's checking account a payment amount; (b) sending the statement to the payer for authorization; (c) receiving the authorized statement back from the payer; and (d) deducting the payment amount from the payer's checking account.

According to a further embodiment of the present invention there is provided a method for receiving payment from an account holder. The method includes the following steps: (a) issuing a periodic statement to the account holder, the statement including an amount owed by the account holder, checking account information of the account holder, and means for the account holder to authorize a deduction of a payment amount from the account holder's checking account; (b) receiving the periodic statement from the account holder, the received periodic statement including the account holder's authorization to deduct the payment amount from the account holder's checking account; and (c) deducting the payment amount from the account holder's checking account.

An advantage of the present invention is that it offers significant cost savings by removing the paper processing of checks.

Another advantage of the present invention is that it results in increased customer satisfaction due to an easier payment method provided by aspects of the present invention—e.g., the customer is not required to write a check.

A still further advantage of the present invention is that it is time efficient and is easy, for both a payer and a payee.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a flowchart illustrating a conventional method for collecting payment of a statement.

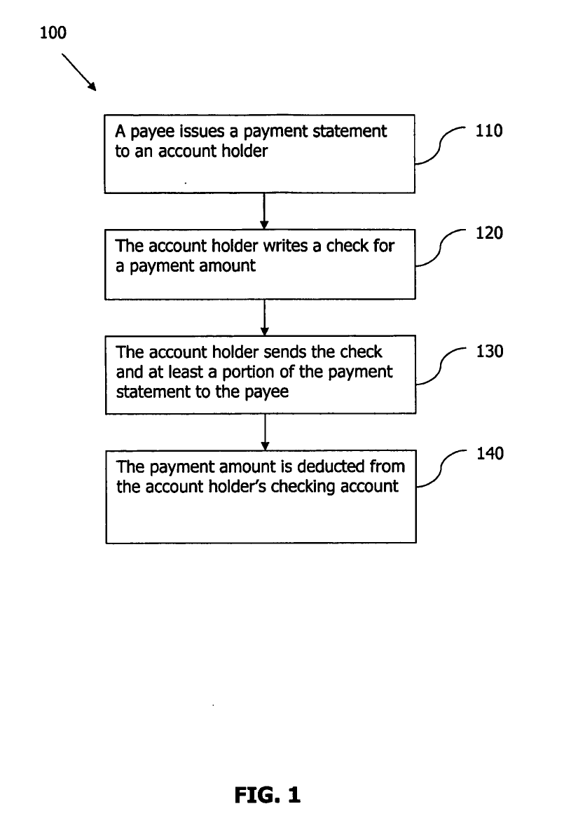

FIG. 2 is a flowchart illustrating a method for facilitating payment of a payment statement by an account holder in accordance with an embodiment of the present invention.

FIG. 3 is a flowchart illustrating a method for obtaining bank account information of an account holder in accordance with an embodiment of the present invention.

FIG. 4 is a flowchart illustrating a method for generating a statement and receiving payment from an account holder in accordance with an embodiment of the present invention.

### DETAILED DESCRIPTION

I. Overview

The present invention is directed to a method for facilitating payment of a statement that does not require the use of a check.

The present invention is now described in more detail herein in terms of the generation and payment of a credit card statement. Description of the invention in the environment of generation and payment of a credit card statement is done for purposes of illustrating the features and advantages of the invention. The invention is not limited to this environment. In fact, after reading the following description, it will be apparent to one skilled in the relevant art(s) how to implement the invention in alternative embodiments (e.g., payment of a mortgage, student loan, auto loan, utility bill, purchase or recharge of a pre-paid or debit card, etc.).

II. Terminology

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

“Open cards” are financial transaction cards that are generally accepted at different merchants. Examples of open cards include the American Express Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments up to ten dollars.

The present invention may be used for payment of any transaction account including mortgages, personal and business loans, lines of credit, utility accounts, open cards, stored value cards, etc. The terms “statement,” “payment statement,” “periodic statement,” and “invoice” are used interchangeably herein to refer to a document (whether paper or electronic) that is provided to an account holder to solicit payment of an amount payable.

The terms “payer,” “account holder”, “consumer”, “customer,” “participant,” and/or the plural form of these terms are used interchangeably throughout herein to refer to a person or entity who is the intended recipient of a statement.

Furthermore, the term “payee” shall mean any person, entity, company that is owed money by an account holder. “Payee” can also mean a delegate, agent or assignee authorized to receive payment on behalf of an actual payee. For example, a payee may be a credit card company such as the American Express Company of New York, N.Y. The payee is typically the issuer of the statement.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

III. Process

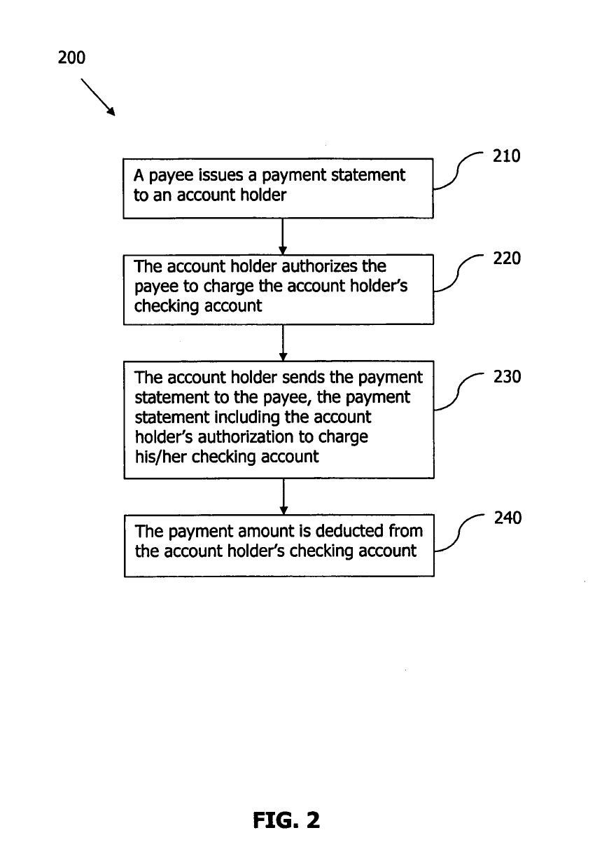

FIG. 2 illustrates a method 200 for expediting the payment process of a statement by an account holder, in accordance with an embodiment of the present invention. The expedited payment process of method 200 does not require the account holder to write a check.

An overview of method 200 follows. Method 200 begins at a step 210 in which a payee issues a payment statement to an account holder. The payment statement includes an amount owed by the account holder, checking account information of the account holder, and means for the account holder to authorize a deduction of a payment amount from the account holder's checking account. Issuance of a statement typically involves generation of the statement followed by delivery of the statement to the account holder/payer. For example, a credit card statement is typically delivered in paper form via a mail service such as the U.S. Postal Service.

In a step 220, after the account holder receives and reviews the statement, the account holder authorizes the payee to deduct a payment amount from the account holder's checking account. For example, the account holder may check a box or fill-in a blank to authorize the deduction of the payment amount from the checking account. The authorization may optionally also (or in lieu of a check box or fill-in blank) involve the account holder providing his/her written or electronic signature as authorization to deduct the payment from the checking account.

In a step 230, the account holder sends the payment statement to the payee. The payment statement now includes the account holder's authorization to deduct a payment amount from his or her checking account. In a step 240 the payment amount is deducted from the account holder's checking account.

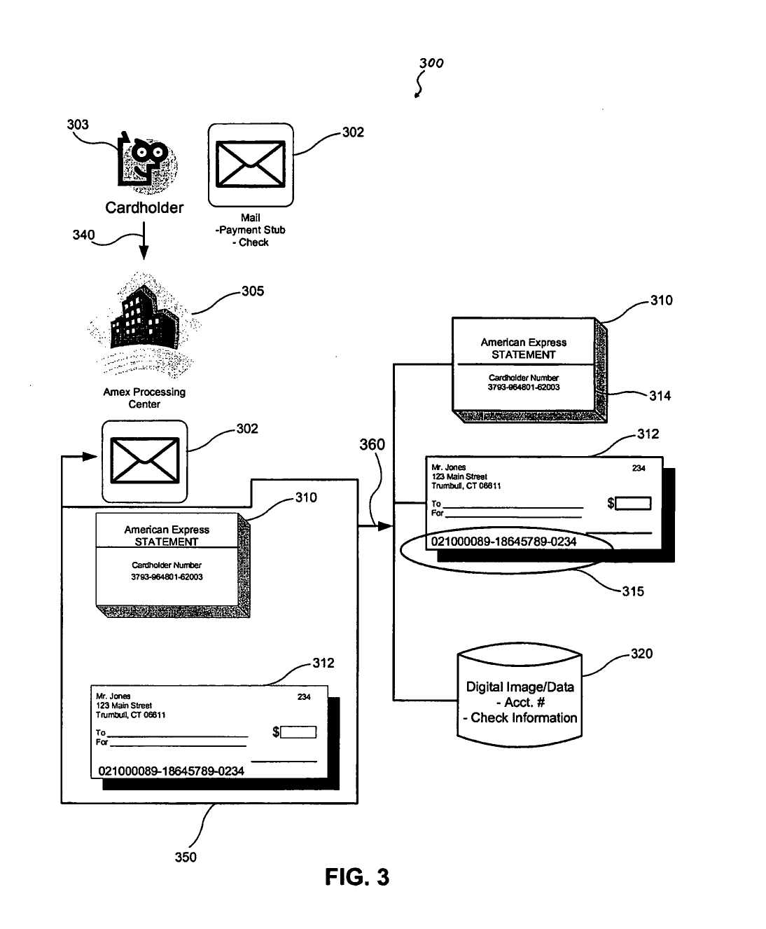

In step 210, it was indicated that the payment statement included the account holder's checking account information. The checking account information may be obtained from the account holder in a variety of ways. FIG. 3 includes a flowchart 300 illustrating an example method by which the account holder's checking account information can be obtained. Flowchart 300 includes an account holder 303 (e.g., card holder), an envelop 302, and a processing center 305.

Flowchart 300 begins at a step 340 in which account holder 303 mails envelop 302 to processing center 305. Mailed envelope 302 includes a statement 310 and a check 312 as illustrated by a box 350. Statement 310 can be, for example, a conventional credit card statement being paid in a conventional manner using conventional check 312. In a step 360, processing center 305 converts information printed on statement 310 and check 312 into digitized information to result in a data set 320, which includes the account holder's account number and checking account information. Data set 320 may be included as part of the processing centers billing and/or account information database.

FIG. 3 shows cardholder number 314 (i.e., account number) as example information printed on statement 310. Other information included on statement 310 that is converted into the digitized information can include, but is not limited to, an amount owed, payment history, and the like. Similarly, FIG. 3 shows a number string 315 (i.e., checking account number) as information printed on check 312 that is converted into digitized information and included in data set 320. Number string 315 can include, but is not limited to, a bank routing number, an account number, and the like.

The information printed on statement 310 can be converted into digital information for inclusion in data set 320 by magnetically and/or optically reading the printed information. For example, the printed information can be magnetic ink character recognition (MICR) encoded information. Additionally or alternatively, the information printed on statement 310 can be optically read using optical character recognition (OCR), which reads information printed on statement 310 as a bit map (i.e., a pattern of dots). Optical bar coding technology can also be used in connection with number string 315 to facilitate automated data capture.

MICR and OCR technologies are well-known. For example, the banking industry has been using MICR technology for several decades to automatically sort and process checks, and more recently libraries and government agencies have used OCR technology to make lengthy printed documents electronically available. Since MICR, OCR and bar coding technologies are well-known by persons skilled in the relevant art(s), these technologies are not described further for the sake of brevity.

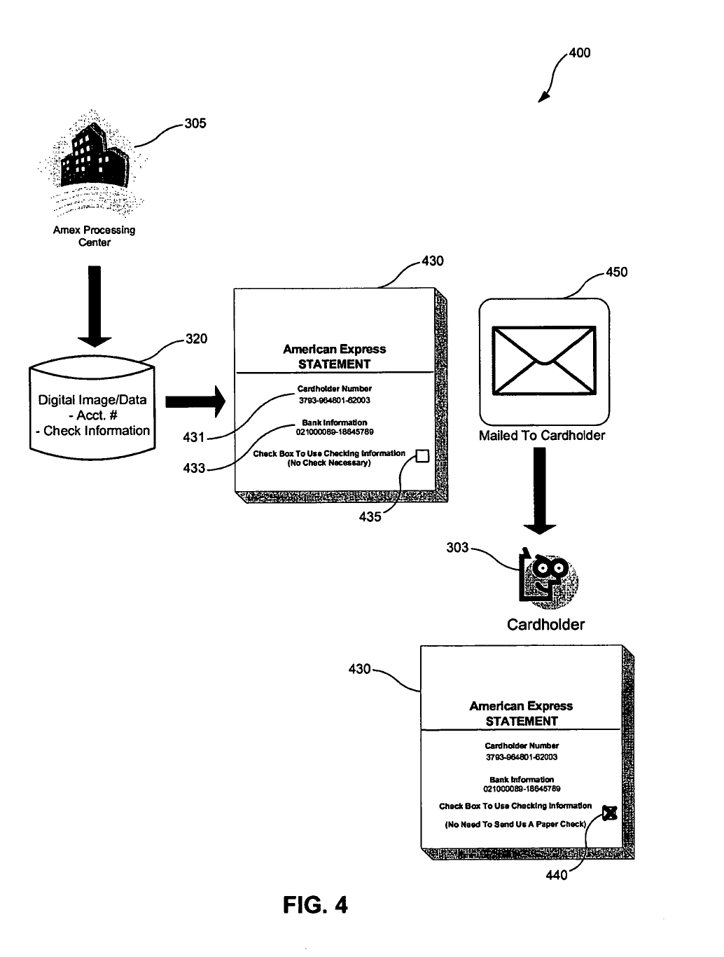

Referring now to FIG. 4, once an account holder's banking/checking account information is obtained (e.g., by method 300), the banking/checking account information can be used to facilitate the payment of a payment statement. FIG. 4 illustrates a method 400 for facilitating the receipt of payment from an account holder. Method 400 does not require the account holder to write a check. Referring to method 400, processing center 305 can print digital information 320 on a statement 430. In this way, statement 430 includes the account holder's account number 431 (e.g., a credit card number), bank information 433 (e.g., checking account information) and means 435 for the account holder to authorize a deduction of a payment.

After statement 430 is produced, processing center 305 encloses statement 430 in envelop 450 and mails it to card holder 303. Upon receipt of statement 430, account holder 303 can indicate on statement 430 that a payment amount is authorized to be deducted from his or her checking account.

Digital information 320 can be stored by processing center 305 (e.g., in an electronic database), so that a payment statement, like statement 430—including an account number, bank information, and means for the account holder to authorize a deduction of a payment amount—can be periodically issued to account holder 303. For example, a payment statement, like statement 430, can be mailed to account holder 303 on a weekly, monthly, or quarterly payment cycle. However, the practice of the present invention is not limited to such payment cycles. A person skilled in the art will appreciate that any payment cycle can be used within the scope and spirit of the present invention.

It is to be appreciated that, while statement 430 illustrates the means for the account holder to authorize a deduction of a payment amount as a box 435 and the account holder's authorization as a check mark 440, the present invention should not be limited by the examples shown in FIG. 4. As discussed above, for example, the means for the account holder to authorize a deduction of a payment amount can include, but is not limited to, a check box, a blank to be filled-in by the account holder, and/or a signature space. In addition, other means may be devised. These include, for example, providing an adhesive sticker to be placed by a payer at a specified location on the statement, providing a perforated portion of the statement that can be punched or torn away, etc. When a banking system requires a signature from the payer, the signature can be used in lieu of or in addition to other means for indicating the authorization.

The example credit card statement environment used herein to illustrate an embodiment of the invention involves a paper invoice that is mailed to an account holder and return of the paper invoice (or a portion thereof) to the payee via mail. In another embodiment, the invoice can be electronically transmitted to the account holder/payer and/or the authorized invoice can be electronically transmitted to the payee.

### IV. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures, which highlight the functionality and advantages of the present invention, are presented for example purposes only. The methodology and architecture of the present invention is sufficiently flexible and configurable, such that it may be utilized in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for producing a payment statement that can be paid by a payer without requiring a check, the method comprising the steps of:
(a) providing the payer's checking account information on the payment statement; and
(b) providing means on the payment statement to solicit payer authorization to charge the payer's checking account a payment amount.

2. The method of claim 1, further comprising:
(c) obtaining the checking account information from a check used by the payer to pay a previous payment statement.

3. The method of claim 1, wherein step (a) comprises:
printing indicia on the statement representing the payer's checking account information that can be at least one of magnetically or optically read.

4. The method of claim 1, wherein step (a) comprises:
printing indicia on the statement, wherein the indicia comprises magnetic ink character recognition (MICR) encoded information.

5. The method of claim 1, wherein step (b) comprises:
providing means on the payment statement to solicit payer authorization to charge the payer's checking account a payment amount, wherein the means to solicit comprises a check box.

6. The method of claim 1, wherein step (b) comprises:
providing means on the payment statement to solicit payer authorization to charge the payer's checking account a payment amount, wherein the means to solicit comprises a blank to be filled-in by the payer.

7. A method for facilitating payment of a statement by a payer, comprising the steps of:
(a) producing a statement that includes an amount owed by the payer, checking account information of the payer, and means on the payment statement to solicit payer authorization to charge the payer's checking account a payment amount;
(b) sending the statement to the payer for authorization;
(c) receiving the authorized statement back from the payer; and
(d) deducting the payment amount from the payer's checking account.

8. The method of claim 7, wherein step (a) comprises:
obtaining the checking account information from a check used by the payer to pay a previous payment statement.

9. The method of claim 7, wherein step (a) comprises:
printing indicia on the statement representing the payer's checking account information that can be at least one of magnetically or optically read.

10. The method of claim 7, wherein step (a) comprises:
printing indicia on the statement, wherein the indicia comprises magnetic ink character recognition (MICR) encoded information.

11. The method of claim 7, wherein step (a) comprises:
producing means on the payment statement to solicit payer authorization to charge the payer's checking account a payment amount, wherein the means to solicit comprises a check box.

12. The method of claim 7, wherein step (a) comprises:
producing means on the payment statement to solicit payer authorization to charge the payer's checking account a payment amount, wherein the means to solicit comprises a blank to be filled-in by the payer.

13. A method for receiving payment from an account holder, comprising the steps of:
(a) issuing a periodic statement to the account holder, the statement including an amount owed by the account holder, checking account information of the account holder, and means for the account holder to authorize a deduction of a payment amount from the account holder's checking account;
(b) receiving the periodic statement from the account holder, the received periodic statement including the account holder's authorization to deduct the payment amount from the account holder's checking account; and
(c) deducting the payment amount from the account holder's checking account.

14. The method of claim 13, further comprising:
(d) obtaining the checking account information from a check used by the account holder to pay a previous statement.

15. The method of claim 13, wherein step (a) comprises:
printing indicia on the statement representing the account holder's checking account information that can be at least one of magnetically or optically read.

16. The method of claim 13, wherein step (a) comprises:
printing indicia on the statement, wherein the indicia comprises magnetic ink character recognition (MICR) encoded information.

17. The method of claim 13, wherein step (a) comprises:
providing means on the payment statement to solicit account holder authorization to charge the account holder's checking account a payment amount, wherein the means to solicit comprises a check box.

18. The method of claim 13, wherein step (a) comprises:
providing means on the payment statement to solicit account holder authorization to charge the account holder's checking account a payment amount, wherein the means to solicit comprises a blank to be filled-in by the payer.
